(19) United States
(12) Patent Application Publication
(10) Pub. No.: US 2020/0126341 A1
(43) Pub. Date: Apr. 23, 2020

(54) Paper Sheet Handling Device And Paper Sheet Handling System

(71) Applicant: Japan Cash Machine Co., Ltd., Osaka (JP)

(72) Inventors: Yousuke MIYASHITA, Osaka (JP); Makoto HASEGAWA, Osaka (JP)

(73) Assignee: Japan Cash Machine Co., Ltd., Osaka (JP)

(21) Appl. No.: 16/626,202

(22) PCT Filed: Mar. 7, 2018
(86) PCT No.: PCT/JP2018/008839

§ 371 Date: Dec. 23, 2019

(30) Foreign Application Priority Data
Jul. 11, 2017 (JP) 2017-135373

(51) Int. Cl. G07D 11/50; G06M 3/02; G07D 11/24; G07D 11/34; G06M 1/28

(52) U.S. Cl. CPC G07D 11/50; G06M 3/02; G06M 1/28; G07D 11/34; G07D 11/24

(57) ABSTRACT

An object of the present invention is to prevent rejection of a subsequent paper sheet even if counting of paper sheets is accelerated. Provided is a paper sheet handling system including a paper sheet identification device that identifies paper sheets, and a paper sheet counting device that counts the paper sheets identified by the paper sheet identification device. The paper sheet handling system generates previous process data including read specific codes in the order of fed paper sheets, and memorizes therein the feed-out number K of paper sheets that have been already fed at the point in time when a specific code of one paper sheet is read. A batch quantity N is an integer larger than the feed-out number K. Every time the specific code is read, the specific code is matched with the previous process data, to specify the Zth paper sheet from the paper sheet with the matched specific code as a batch expected paper sheet. Specific codes from the batch expected paper sheet to the paper sheet K before thereof are extracted from the previous process data. When it is judged that any of the specific codes from the batch expected paper sheet to the paper sheet K before thereof matches with the read specific code, an operation of a second feeding unit is stopped.

### FIELD

The present invention relates to a paper sheet handling system that handles paper sheets.

### BACKGROUND

Conventionally, a banknote counting machine that counts banknotes for each of a set batch quantity has been known. For example, according to a banknote counting machine described in Patent Literature 1, banknotes to be counted are set in a hopper. Denomination, authenticity, and the like of the banknotes fed from the hopper are recognized by a recognition unit. The number of banknotes with a denomination recognized to be the same as the denomination preset as a counting target by the recognition unit is counted by a counting unit. A count value accumulated for each denomination is held in a memory unit. When the counted number of banknotes with a specific denomination becomes equal to the preset batch quantity, feeding of the banknotes from the hopper is stopped by a stopping unit.

### CITATION LIST

### Patent Literature

Patent Literature 1: Japanese Patent Application Laid-open No. H9-106465

### SUMMARY

### Technical Problem

Such a type of counting machine that has a configuration in which before recognition of a banknote by a recognition unit is completed, a subsequent banknote is fed toward the recognition unit can be considered to accelerate counting of the banknotes. However, in the counting device having such a configuration, even if feeding of the banknote is stopped at the point in time when the recognition unit recognizes the denomination and it is ascertained that the counted number of banknotes of the recognized denomination is equal to a batch quantity, the subsequent banknote has been already fed. In this case, according to the device described in Patent Literature 1, the subsequent banknote already fed is rejected. This applies not only to banknotes but also to general paper sheets including marketable securities.

The present invention has been achieved in view of the above problem, and an object of the present invention is to provide a paper sheet handling system that does not reject a subsequent paper sheet already fed, even if counting of paper sheets is accelerated.

### Solution to Problem

An aspect of the present invention provides a paper sheet handling system comprising a paper sheet identification device that identifies paper sheets and a paper sheet counting device that counts the paper sheets identified by the paper sheet identification device, wherein the paper sheet identification device includes a first feeding unit that feeds one by one a plurality of the paper sheets stacked in a slot, a first read unit that reads a specific code described on a surface of the paper sheet fed by the first feeding unit to uniquely specify the paper sheet, a first storage unit that stacks and stores the paper sheets of which the specific codes have been read by the first read unit, and a data generation unit that generates previous process data including the specific codes read by the first read unit in order of the paper sheets fed by the first feeding unit, the paper sheet counting device includes a second feeding unit that feeds one by one the paper sheets taken out from the first storage unit and stacked and arranged in a slot, a second read unit that reads the specific code described on a surface of the paper sheet fed by the second feeding unit, an acceptance judgment unit that judges whether to accept the paper sheet fed by the second feeding unit, a second storage unit that can store therein the paper sheet up to a set batch quantity N, a transport unit that transports the paper sheet judged to be acceptable by the acceptance judgment unit to the second storage unit, an acquisition unit that acquires the previous process data, a transport control unit that controls operations of the second feeding unit and the transport unit, a memory that memorizes therein a feed-out number K of paper sheets (K is a positive integer), which have been already fed to between the second feeding unit and the second read unit, at a point in time when the specific code of one of the paper sheets is read by the second read unit, and a counting control unit that counts number of paper sheets to be stored in the second storage unit, based on the previous process data and the specific code read by the second read unit, the batch quantity N is an integer larger than the feed-out number K, the counting control unit subtracts a remaining number of sheets Z by one up to the batch quantity N, every time it is judged to accept the paper sheet after an operation of the second feeding unit has been started, maintains the remaining number of sheets Z without performing subtraction, when it is judged not to accept the paper sheet, matches the read specific code that is the specific code read by the second read unit with the previous process data to specify a Zth paper sheet from the paper sheet with the matched specific code as a batch expected paper sheet, every time the specific code is read by the second read unit, extracts the specific codes from the batch expected paper sheet to a paper sheet K before thereof from the previous process data, and judges whether any of the specific codes from the batch expected paper sheet to the paper sheet K before thereof matches with the read specific code, and the transport control unit stops the operation of the second feeding unit, when the counting control unit judges that any of the specific codes from the batch expected paper sheet to the paper sheet K before thereof matches with the read specific code.

According to the present aspect, the feed-out number K of paper sheets, which have been already fed to between the second feeding unit and the second read unit at the point in time when the specific code of one paper sheet is read by the second read unit, is memorized in the memory. After the operation of the second feeding unit is started, every time it is judged to accept the paper sheet, the remaining number of sheets Z is subtracted by one up to the batch quantity N. When it is judged not to accept the paper sheet, the remaining number of sheets Z is maintained without performing subtraction. Therefore, the remaining number of sheets Z up to the batch quantity N can be accurately counted.

The read specific code is matched with the previous process data and the Zth paper sheet from the read specific code is specified as the batch expected paper sheet. The specific codes from the batch expected paper sheet to the paper sheet K before thereof are extracted from the previous process data. It is judged whether any of the specific codes from the batch expected paper sheet to the paper sheet K before thereof matches with the read specific code. When it is judged that any of the specific codes from the batch expected paper sheet to the paper sheet K before thereof matches with the read specific code, the operation of the second feeding unit is stopped.

At the point in time when the operation of the second feeding unit is stopped, paper sheets up to the feed-out number K have been already fed. Since the Kth paper sheet of the number K to be fed corresponds to the batch expected paper sheet, which is the Zth paper sheet, it means that the batch quantity N has been fed by the second feeding unit. Therefore, according to the present aspect, it can be prevented that the paper sheets exceeding the batch quantity N are fed by the second feeding unit. As a result, there is such an advantage that even if counting of the paper sheets is accelerated, the subsequent paper sheet already fed is not rejected uselessly.

In the above aspect, for example, the counting control unit may calculate the number of sheets Y up to the batch expected paper sheet, which is the Zth paper sheet, after the operation of the second feeding unit is stopped and the acceptance judgment unit judges whether to accept K paper sheets. The transport control unit may feed the paper sheets by the number of sheets Y by restarting the operation of the second feeding unit.

According to the present aspect, after the operation of the second feeding unit is stopped and the acceptance judgment unit judges whether to accept K paper sheets, the number of sheets Y up to the batch expected paper sheet, which is the Zth paper sheet, is calculated. The operation of the second feeding unit is restarted and the paper sheets are fed by the number of sheets Y. Therefore, according to the present aspect, the number of paper sheets insufficient for the batch quantity N can be fed.

In the above aspect, after the operation of the second feeding unit is restarted, for example, the counting control unit may subtract the remaining number of sheets Z by one, every time it is judged to accept the paper sheet, and when it is judged not to accept the paper sheet, the counting control unit may maintain the remaining number of sheets Z without performing subtraction, and judge whether the remaining number of sheets Z becomes zero. The transport control unit may stop the operation of the transport unit when the counting control unit judges that the remaining number of sheets Z becomes zero.

According to the present aspect, after the operation of the second feeding unit is restarted, every time it is judged to accept the paper sheet, the remaining number of sheets Z is subtracted by one up to the batch quantity N, and when it is judged not to accept the paper sheet, the remaining number of sheets Z is maintained without performing subtraction. When it is judged that the remaining number of sheets Z becomes zero, the operation of the transport unit is stopped. Therefore, according to the present aspect, even if there is a paper sheet judged not to be acceptable after the operation of the second feeding unit is restarted, the second feeding unit can feed the paper sheets up to the batch quantity N.

In the above aspect, for example, the paper sheet can include paper sheets issued in a plurality of different countries.

In the above aspect, for example, a management device configured to be able to communicate with the paper sheet identification device and the paper sheet counting device respectively may be further provided. The paper sheet identification device may further include a first communication unit that transmits the previous process data to the management device. The management device may include a management communication unit that receives the previous process data transmitted from the first communication unit of the paper sheet identification device, and a management memory unit that memorizes therein the previous process data received by the management communication unit. The management communication unit may transmit the previous process data memorized in the management memory unit to the paper sheet counting device. The acquisition unit may receive the previous process data transmitted from the management communication unit.

In the above aspect, for example, the paper sheet identification device may further include a first communication unit that stores the previous process data in a portable memory configured communicably. The acquisition unit may acquire the previous process data from the portable memory in which the previous process data is stored.

### Advantageous Effects of Invention

According to the present invention, at a point in time when an operation of a second feeding unit is stopped, paper sheets up to a feed-out number K have been already fed. Since the Kth paper sheet of the feed-out number K corresponds to a batch expected paper sheet, which is the Zth paper sheet, it means that a batch quantity N has been fed by the second feeding unit. Therefore, it can be prevented that the paper sheets exceeding the batch quantity N are fed by the second feeding unit. As a result, there is such an advantage that even if counting of the paper sheets is accelerated, the subsequent paper sheet already fed is not rejected uselessly.

### BRIEF DESCRIPTION OF DRAWINGS

FIG. 1 is a block diagram schematically illustrating a configuration example of a banknote handling system according to an embodiment of the present invention.

FIG. 2 is a block diagram schematically illustrating a configuration example of a deposit machine.

FIG. 3 is a diagram schematically illustrating an example of previous process data generated by the deposit machine.

FIG. 4 is a block diagram schematically illustrating a configuration example of a server device.

FIG. 5 is a block diagram schematically illustrating a configuration example of a counting machine.

FIG. 6 is a diagram schematically illustrating a banknote fed by a feeding motor.

FIG. 7 is a flowchart schematically illustrating an operation example of the deposit machine.

FIG. 8 is a flowchart schematically illustrating an operation example of the counting machine to be performed before starting a banknote counting operation.

FIG. 9 is a flowchart schematically illustrating an example of a banknote counting operation of the counting machine.

FIG. 10 is a flowchart schematically illustrating an example of a banknote counting operation of the counting machine.

FIG. 11 is a flowchart schematically illustrating an example of a banknote counting operation of the counting machine.

FIG. 12 is a diagram illustrating counting information for specifically explaining a process of the banknote counting operation.

### DESCRIPTION OF EMBODIMENTS

(Knowledge as Basis of Present Invention)

Knowledge as the basis of the present invention is explained first. As described above, if such a configuration that a subsequent banknote is fed toward a recognition unit before recognition of a banknote is completed in the recognition unit is adopted to the device described in Patent Literature 1 described above in order to accelerate counting of banknotes, even if feeding of banknotes is stopped at the point in time when the counted number has reached the batch quantity, the already fed banknote has to be rejected. However, in this case, the banknote is rejected every time the counted number has reached the batch quantity. Therefore, the number of rejected banknotes increases to decrease counting efficiency.

As a measure against this problem, such a configuration can be considered that when the counted number approaches the batch quantity, an interval to feed the banknotes is increased to feed the next banknote after completion of recognition of the banknote. In this case, even if feeding of the banknotes is stopped at the point in time when the counted number has reached the batch quantity, because the subsequent banknote has not been fed, the number of rejected banknotes can be decreased. However, with this configuration, every time the counted number approaches the batch quantity, a feed rate of banknotes drops to decrease the productivity. Further, if the feeding interval of banknotes increases during the operation, a user may recognize it as a failure.

As another measure, such a configuration can be considered that a place to accumulate banknotes is provided in a transport path of banknotes, to hold already fed banknotes temporarily at the point in time when the counted number has reached the batch quantity. However, with this configuration, the size of the device increases because a transport path becomes long, to lead to a cost increase of the device, which is not preferable.

On the other hand, conventionally, when authenticity of a banknote is identified in a banknote identification device such as a deposit machine installed in respective shops of, for example, distribution industry, the banknote identified as authentic is transferred to a cash center. In the cash center, a counting machine is installed, and the banknotes are counted at a high speed in the counting machine. Therefore, the present inventors have arrived at a paper sheet handling system in which previous process data acquired by a deposit machine being a device in a previous process can be used by a counting machine being a device in a post-process, so that a subsequent paper sheet already fed is not rejected, while counting the banknotes at a high speed.

### Embodiment

An embodiment of the present invention will be explained below with reference to the drawings. In the respective drawings, like constituent elements are denoted by like reference signs and detailed descriptions thereof are omitted appropriately.

(Configuration)

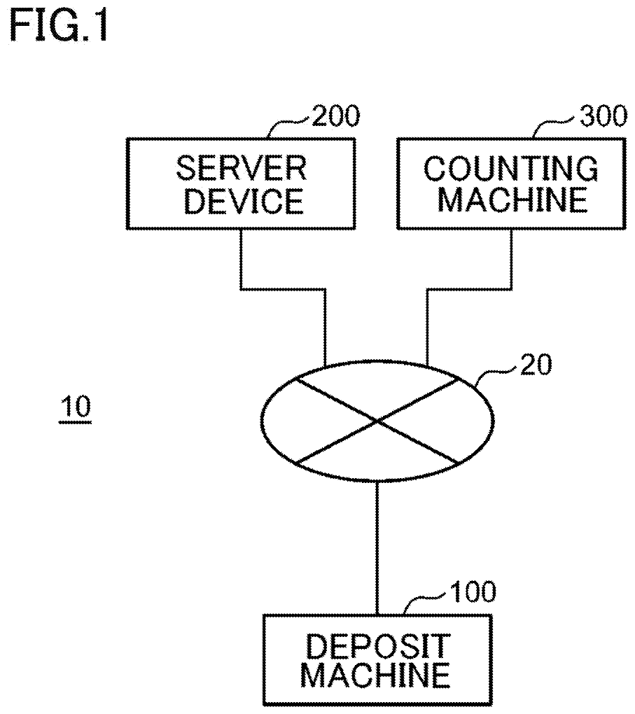

FIG. 1 is a block diagram schematically illustrating a configuration example of a banknote handling system 10 according to the present embodiment. As illustrated in FIG. 1, a banknote handling system 10 according to the present embodiment includes a deposit machine 100, a server device 200, and a counting machine 300. The deposit machine 100 is installed in respective shops of, for example, distribution industry. The server device 200 and the counting machine 300 are installed in, for example, a cash center of distribution industry.

The deposit machine 100 identifies the authenticity of banknotes paid by a customer who comes to a shop and manages the number of banknotes and the like. The banknotes identified as authentic by the deposit machine 100 are transferred to the cash center. The counting machine 300 manages the denomination, the number of banknotes, and the like of the banknotes transferred from the shops. The server device 200 manages the denomination, the number of banknotes, and the like of the banknotes. The server device 200 is configured by a computer, for example, a personal computer.

The deposit machine 100, the server device 200, and the counting machine 300 are respectively connected to a network 20. The network 20 can include, for example, a wired or wireless local area network (LAN), and can include the Internet.

The deposit machine 100 and the server device 200 are configured to be able to communicate with each other, for example, via the Internet of the network 20. The counting machine 300 and the server device 200 are configured to be able to communicate with each other, for example, via the LAN of the network 20.

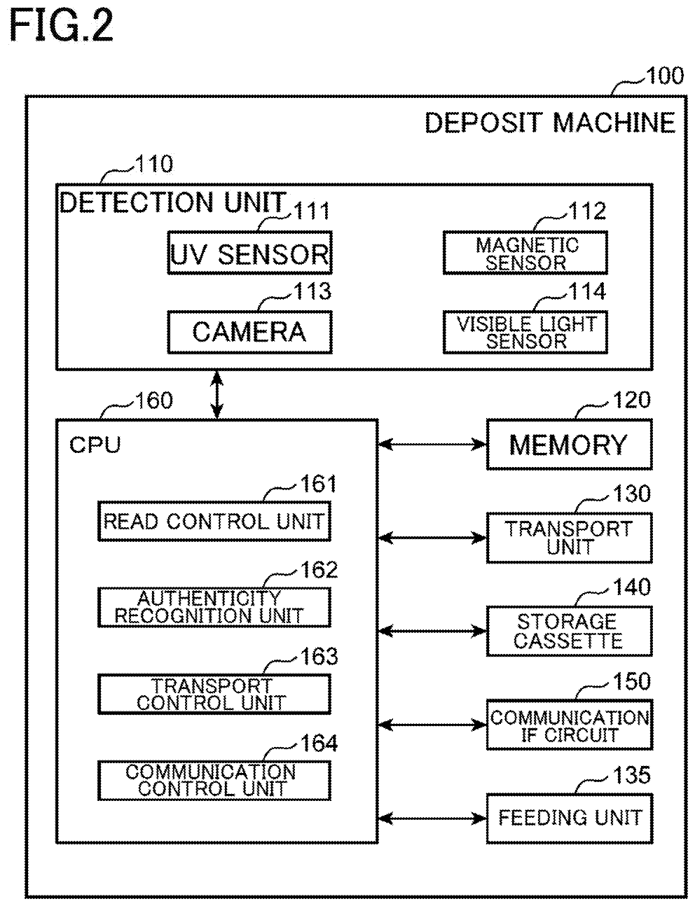

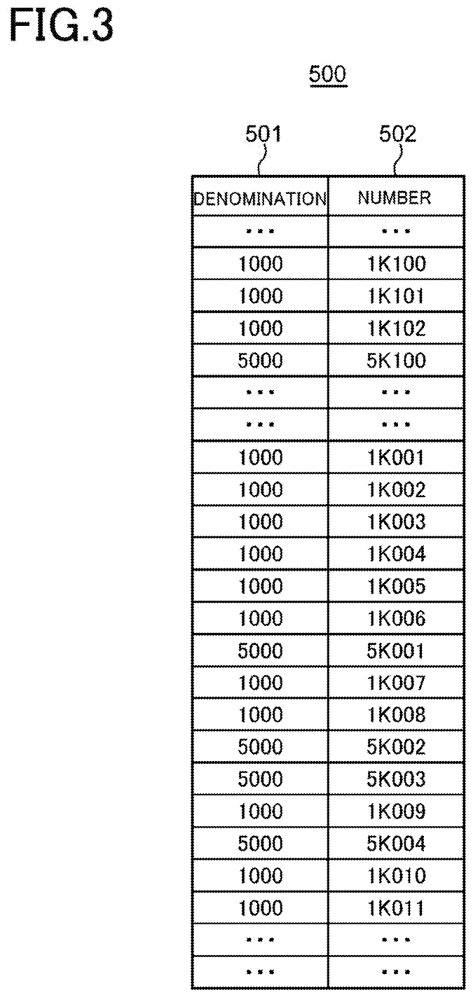

FIG. 2 is a block diagram schematically illustrating a configuration example of the deposit machine 100 included in the banknote handling system 10 in FIG. 1. FIG. 3 is a diagram schematically illustrating an example of previous process data generated by the deposit machine 100.

As illustrated in FIG. 2, the deposit machine 100 includes a detection unit 110, a memory 120, a transport unit 130, a feeding unit 135, a storage cassette 140, a communication interface (IF) circuit 150, and a central processing unit (CPU) 160. The detection unit 110 includes an ultraviolet (UV) sensor 111, a magnetic sensor 112, a camera 113, and a visible light sensor 114.

The memory 120 is configured by, for example, a semiconductor memory. The memory 120 includes, for example, a read only memory (ROM), a random access memory (RAM), and an electrically erasable programmable ROM (EEPROM). The ROM of the memory 120 memorizes therein a control program of the present embodiment that causes the CPU 160 to operate. The CPU 160 operates according to the control program of the present embodiment memorized in the memory 120, thereby to function as a read control unit 161, an authenticity recognition unit 162, a transport control unit 163, and a communication control unit 164. The respective functions of the CPU 160 are described later.

The transport unit 130 and the feeding unit 135 are connected to the CPU 160 and are controlled by the transport control unit 163 to operate. The transport unit 130 includes a motor for transporting banknotes along a transport path, a transport-destination switching unit that switches a transport destination, and the like. The feeding unit 135 includes a feeding motor and the like for feeding banknotes stacked in a slot. The transport control unit 163 operates the feeding unit 135 to feed the banknotes one by one from the banknotes stacked in the slot of the deposit machine 100 and transports the banknotes to the detection unit 110. The transport control unit 163 operates the transport unit 130 to transport banknotes, which have been transported from the slot to the detection unit 110, from the detection unit 110 to the storage cassette 140 or to a reject unit (not illustrated) along a predetermined transport path.

The storage cassette 140 stores therein banknotes identified as authentic. The storage cassette 140 is connected to the CPU 160 and includes a full-filling sensor (not illustrated) that detects that the storage cassette 140 has become full of banknotes to be stored. When the full-filling sensor detects that the storage cassette 140 has become full of stored banknotes, the transport control unit 163 stops transport of banknotes by the feeding unit 135 and the transport unit 130. The storage cassette 140 can be configured to be removable from the deposit machine 100. In this case, the banknotes can be transferred in a state stored in the storage cassette 140.

The communication IF circuit 150 is connected to the CPU 160 and operates under control of the communication control unit 164. The communication IF circuit 150 communicates with the server device 200 via the network 20. The communication IF circuit 150 generates a communication signal storing therein previous process data (described later) to be transmitted, which has been input from the communication control unit 164 of the CPU 160, according to a communication protocol used in the network 20. The communication IF circuit 150 transmits the generated communication signal to the server device 200 via the network

The UV sensor 111 of the detection unit 110 includes a light-emitting element that irradiates ultraviolet light toward a banknote and a light-receiving element that receives reflected light of the ultraviolet light that is reflected by the banknote. The UV sensor 111 outputs an ultraviolet light signal corresponding to the reflected light received by the light-receiving element to the CPU 160. The magnetic sensor 112 of the detection unit 110 detects magnetism output from the banknote transported by the transport unit 130 and outputs a magnetic signal corresponding to the detected magnetism to the CPU 160. The camera 113 of the detection unit 110 takes an image of the banknote and outputs an imaging signal acquired by taking the image to the CPU 160. The visible light sensor 114 of the detection unit 110 includes a light-emitting element that irradiates visible light toward a banknote and a light-receiving element that receives reflected light of the visible light that is reflected by the banknote. The visible light sensor 114 outputs a visible light signal corresponding to the reflected light received by the light-receiving element to the CPU 160.

The read control unit 161 of the CPU 160 performs image processing to the imaging signal output from the camera 113 to read a serial number formed by alphanumeric characters. The serial number represents a sequential serial number of a banknote. Therefore, by reading the serial number (corresponding to an example of a specific code), a banknote can be specified.

The authenticity recognition unit 162 of the CPU 160 identifies the authenticity of a banknote transported by the transport unit 130 based on an ultraviolet light signal output from the UV sensor 111, a magnetic signal output from the magnetic sensor 112, and a visible light signal output from the visible light sensor 114. The authenticity recognition unit 162 notifies the transport control unit 163 of the authenticity identification result. Further, the authenticity recognition unit 162 determines the denomination of a banknote based on the visible light signal output from the visible light sensor 114.

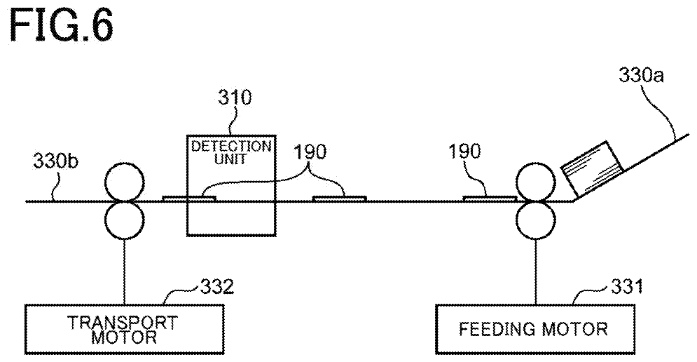

Further, the authenticity recognition unit 162 generates previous process data 500 and stores the generated previous process data 500 in the memory 120. As illustrated in FIG. 3, the previous process data 500 includes a serial number column 502 representing a serial number read by the read control unit 161 from a banknote 190 to be identified (FIG. 6), and a denomination column 501 representing the denomination (corresponding to an example of an identification result) of the banknote 190 associated with the serial number column 502. The previous process data 500 includes correspondence data between the denomination column 501 and the serial number column 502 in the order of the banknotes 190 to be identified (that is, in the order of banknotes 190 delivered from the slot by the transport unit 130).

Upon operation of a start switch provided on, for example, an external surface of the deposit machine 100, the transport control unit 163 causes the transport unit 130 to start operation, and delivers the banknotes stacked in the slot one by one and transports the banknotes to the detection unit 110. When the banknote transported to the detection unit 110 is identified as authentic by the authenticity recognition unit 162, the transport control unit 163 transports the banknote to the storage cassette 140. When the banknote transported to the detection unit 110 is identified as counterfeit by the authenticity recognition unit 162, the transport control unit 163 transports the banknote to the reject unit (not illustrated) along a transport path diverted from the transport path to the storage cassette 140.

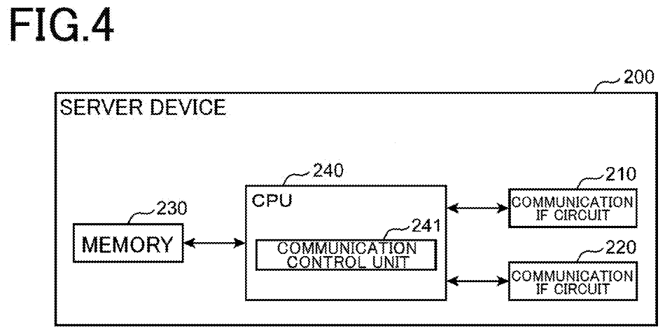

FIG. 4 is a block diagram schematically illustrating a configuration example of the server device 200 included in the banknote handling system 10 in FIG. 1. The server device 200 manages the previous process data transmitted from the deposit machine 100. The server device 200 includes, as illustrated in FIG. 4, communication IF circuits 210 and 220, a memory 230, and a CPU 240. The CPU 240 includes a communication control unit 241.

The communication IF circuits 210 and 220 are connected to the CPU 240 to operate under control of the communication control unit 241 of the CPU 240. The communication IF circuit 210 receives a communication signal transmitted from the deposit machine 100 via the network 20. The communication IF circuit 210 retrieves the previous process data included in the received communication signal and outputs the retrieved previous process data to the CPU 240.

The communication IF circuit 220 communicates with the counting machine 300 via the network 20. The communication IF circuit 220 generates a communication signal storing therein the previous process data input from the CPU 240 according to a communication protocol used in the network 20. The communication IF circuit 220 transmits the generated communication signal to the counting machine 300 via the network 20. The communication IF circuit 220 can include a communication circuit conforming to, for example, IEEE802.11 standard.

The memory 230 is configured by, for example, a semiconductor memory. The memory 230 includes, for example, a ROM, a PAM, and an EEPROM. The ROM of the memory 230 memorizes therein a control program of the present embodiment that causes the CPU 240 to operate.

The CPU 240 operates according to the control program memorized in the memory 230 to function as the communication control unit 241. The communication control unit 241 stores the previous process data transmitted from the deposit machine 100 and received by the communication IF circuit 210 in the memory 230. When transmission of the previous process data stored in the memory 230 is requested from the counting machine 300, the communication control unit 241 reads out the previous process data from the memory 230, generates a communication signal storing therein the read previous process data, and transmits the generated communication signal to the counting machine 300.

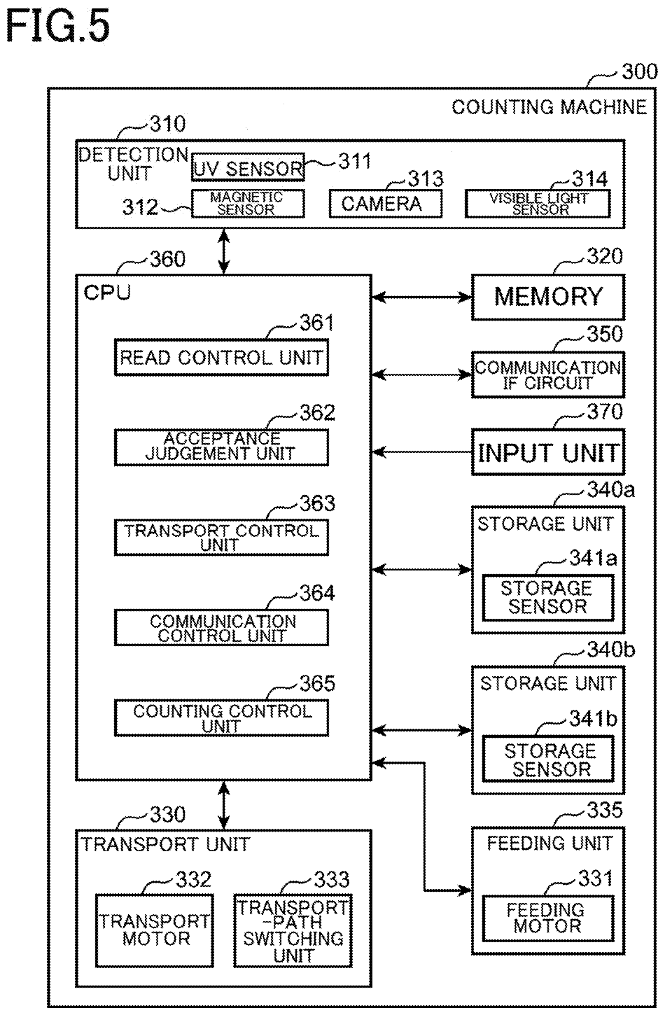

FIG. 5 is a block diagram schematically illustrating a configuration example of the counting machine 300 included in the banknote handling system 10 in FIG. 1. FIG. 6 is a diagram schematically illustrating a banknote 190 fed by a feeding motor 331.

As illustrated in FIG. 5, the counting machine 300 includes a detection unit 310, a memory 320, a transport unit 330, a feeding unit 335, storage units 340a and 340b, a communication IF circuit 350, a CPU 360, and an input unit 370. The transport unit 330 includes a transport motor 332 and a transport-path switching unit 333. The feeding unit 335 includes the feeding motor 331. The storage units 340a and 340b respectively include a storage sensor 341a and a storage sensor 341b.

The detection unit 310 includes a UV sensor 311, a magnetic sensor 312, a camera 313, and a visible light sensor 314. The U sensor 311, the magnetic sensor 312, the camera 313, and the visible light sensor 314 of the detection unit 310 respectively function in the same manner as those of the UV sensor 111, the magnetic sensor 112, the camera 113, and the visible light sensor 114 of the detection unit 110 of the deposit machine 100 (FIG. 2).

The memory 320 is configured by, for example, a semiconductor memory. The memory 320 includes, for example, a ROM, a PAM, and an EEPROM. The ROM of the memory 320 memorizes therein a control program of the present embodiment that causes the CPU 360 to operate. The CPU 360 operates according to the control program of the present embodiment memorized in the memory 320, thereby to function as a read control unit 361, an acceptance judgment unit 362, a transport control unit 363, a communication control unit 364, and a counting control unit 365.

The transport unit 330 and the feeding unit 335 are connected to the CPU 360 and operate under control of the transport control unit 363. That is, the transport control unit 363 causes the feeding motor 331 to operate to feed a plurality of banknotes 190 stacked in a slot of the counting machine 300 one by one and transports the banknotes 190 to the detection unit 310. The transport control unit 363 causes the transport motor 332 to operate to transport the banknotes 190 transported from the slot to the detection unit 310 from the detection unit 310 to the storage units 340a and 340b, or the reject unit (not illustrated).

As illustrated in FIG. 6, the banknotes 190 stacked in a slot 330a of the counting machine 300 are fed one by one along a transport path 330b by the feeding motor 331. According to the present embodiment, the feeding motor 331 is controlled by the transport control unit 363, and at the point in time when a serial number of a banknote is read by the read control unit 361 based on an image of the banknote 190 taken by the camera 313, the feeding motor 331 has already fed the banknotes 190 up to the feed-out number K (K is a positive integer) to between the detection unit 310 and the feeding motor 331. Accordingly, the counting machine 300 according to the present embodiment can count banknotes at a high speed. According to the present embodiment, K=2 as illustrated in FIG. 6. The memory 320 memorizes therein the feed-out number K beforehand along a predetermined transport path.

The storage units 340a and 340b store therein banknotes 190 up to the set batch quantity N. According to the present embodiment, the storage unit 340a stores therein, for example, banknotes of 1000 yen and the storage unit 340b stores therein, for example, banknotes of 5000 yen. The storage sensors 341a and 341b respectively detect that the banknotes 190 have been stored in the storage units 340a and 340b. The transport control unit 363 determines that the banknotes 190 have been stored respectively in the storage units 340a and 340b based on detection signals from the storage sensors 341a and 341b.

The communication IF circuit 350 is connected to the CPU 360 and operates under control of the communication control unit 364. That is, the communication control unit 364 controls the operation of the communication IF circuit 350 to control communication with the server device 200 via the network 20. For example, when it is detected that a bundle of banknotes 190 is stacked in the slot 330a, the communication IF circuit 350 transmits a communication signal requesting transmission of previous process data to the server device 200, under control of the communication control unit 364. When the communication IF circuit 350 receives a communication signal transmitted from the server device 200, the communication control unit 364 retrieves the previous process data from the received communication signal and stores the retrieved previous process data in, for example, the RAM of the memory 320. The communication IF circuit 350 includes a communication circuit conforming to the same communication standard as the communication IF circuit 220 of the server device 200 (FIG. 4).

The read control unit 361 of the CPU 360 functions in the same manner as that of the read control unit 161 of the CPU 160 of the deposit machine 100 (FIG. 2). That is, the read control unit 361 performs image processing to an imaging signal output from the camera 313 to read a serial number formed by alphanumeric characters described on the banknote 190. The read control unit 361 stores the read serial number in, for example, the RAM of the memory 320.

The acceptance judgment unit 362 judges whether to accept the banknote 190 based on a detection result of the detection unit 310. The acceptance judgment unit 362 identifies authenticity of the banknote 190 based on an ultraviolet light signal output from the UV sensor 311, a magnetic signal output from the magnetic sensor 312, and a visible light signal output from the visible light sensor 314. The acceptance judgment unit 362 determines the denomination of the banknote based on the visible light signal output from the visible light sensor 314 by using the same method as that of the authenticity recognition unit 162 (FIG. 2).

When the banknote 190 is identified as counterfeit, when the read control unit 361 cannot read the serial number of the banknote 190, when the denomination of the banknote 190 cannot be determined because the banknote 190 is obliquely transported, or the like, the acceptance judgment unit 362 judges not to accept the banknote 190. The acceptance judgment unit 362 notifies the transport control unit 363 of a judgment result whether to accept the banknote 190, and a determination result of the denomination of the banknote.

The transport-path switching unit 333 switches a transport path of banknotes after having passed the detection unit 310 under control of the transport control unit 363. That is, when the acceptance judgment unit 362 judges not to accept the banknote 190 transported to the detection unit 310, the transport control unit 363 controls the transport-path switching unit 333 to transport the banknote 190 to the reject unit (not illustrated).

The transport control unit 363 controls the transport-path switching unit 333 according to the determination result of the denomination of the banknote, and switches the transport destination of banknotes with the denomination of “1000 yen” to the storage unit 340a, and switches the transport destination of banknotes with the denomination of “5000 yen” to the storage unit 340b. The counting control unit 365 controls counting of the banknotes 190 until reaching the batch quantity N. A specific function of the counting control unit 365 is described later.

The input unit 370 includes, for example, a ten-key switch. When operated by a user, the input unit 370 outputs an operation signal indicating an operation content thereof to the CPU 360. According to the present embodiment, the counting control unit 365 sets the batch quantity N of the banknotes 190 to be stored in the storage units 340a and 340b according to an operation of the input unit 370 by the user.

In the present embodiment, the deposit machine 100 corresponds to an example of a paper sheet identification device, and the counting machine 300 corresponds to an example of a paper sheet counting device. The camera 113 and the read control unit 161 correspond to an example of the first read unit, and the camera 313 and the read control unit 361 correspond to an example of the second read unit. The authentication recognition unit 162 corresponds to an example of the data generation unit. The feeding unit 135 corresponds to an example of the first feeding unit, the feeding unit 335 corresponds to an example of the second feeding unit, and the transport unit 330 corresponds to an example of the transport unit. The storage cassette 140 corresponds to an example of the first storage unit, and storage units 340a and 340b correspond to an example of the second storage unit. The communication IF circuit 350 and the communication control unit 364 correspond to an example of the acquisition unit. The server device 200 corresponds to an example of the management device, the communication IF circuits 210 and 220, and the communication control unit 241 correspond to an example of the management communication unit, and the memory 230 corresponds to an example of the management memory unit. The communication IF circuit 150 and the communication control unit 164 correspond to an example of the first communication unit.

(Operation)

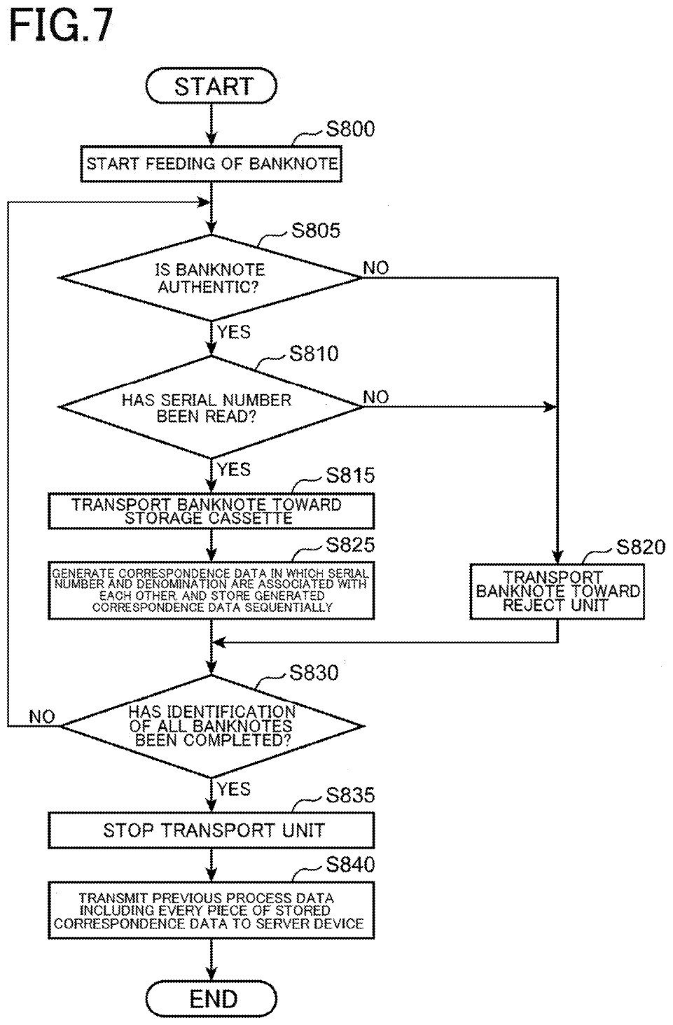

FIG. 7 is a flowchart schematically illustrating an operation example of the deposit machine 100. For example, an operation illustrated in FIG. 7 is started automatically when a bundle of banknotes is set in the slot of the deposit machine 100 or when a start switch provided in the deposit machine 100 is operated.

At step S800, the transport control unit 163 controls the operation of the feeding unit 135 to start feeding of banknotes one by one from the bundle of banknotes stacked in the slot. At step S805, the authenticity recognition unit 162 identifies whether the banknote is authentic. At this time, if the banknote is authentic, the authenticity recognition unit 162 determines the denomination of the banknote. If the banknote is counterfeit (NO at step S805), the process proceeds to step S820. On the other hand, if the banknote is authentic (YES at step 3805), the process proceeds to step S810.

At step S310, the read control unit 161 judges whether a serial number has been read. If the serial number has not been read (NO at step S810), the process proceeds to step S820. At step S820, the transport control unit 163 switches a transport destination of the banknote to transport the banknote to the reject unit, and thereafter, the process proceeds to step S830. On the other hand, if the serial number has been read (YES at step S810), the process proceeds to step S815. At step 3815, the transport control unit 163 transports the banknote to the storage cassette 140.

At step S325, the authenticity recognition unit 162 generates correspondence data in which the serial number and the denomination of the banknote are associated with each other, and sequentially stores the generated correspondence data in the memory 120. At step S830, the CPU 160 judges whether identification of all the banknotes stacked in the slot has been completed. If identification of all the banknotes has not been completed (NO at step S830), the process returns to step S805 to repeat steps thereafter. On the other hand, if identification of all the banknotes has been completed (YES at step S830), the process proceeds to step S835.

At step S835, the transport control unit 163 stops the operation of the transport unit 130. At step S840, the communication control unit 164 controls the operation of the communication IF circuit 150 to transmit the previous process data 500 (FIG. 3) including all the pieces of correspondence data stored in the memory 120 to the server device 200 via the network 20. Thereafter, the operation in FIG. 7 ends.

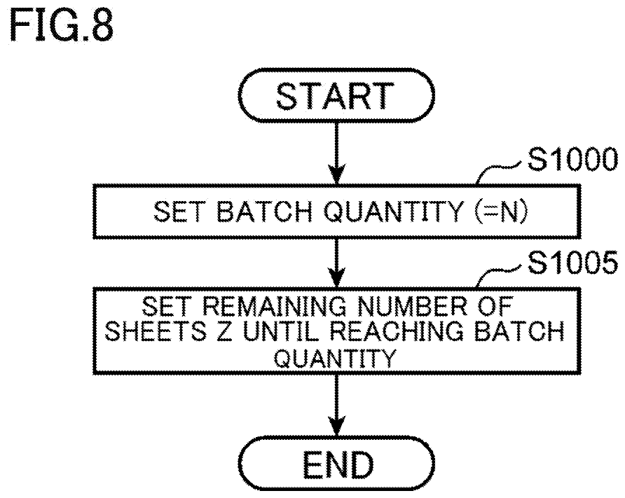

FIG. 8 is a flowchart schematically illustrating an operation example of the counting machine 300 to be performed before starting a banknote counting operation. At step S1000, the counting control unit 365 sets the batch quantity N of banknotes 190 to be stored in the storage units 340a and 340b, according to an operation of the input unit 370 by a user. The counting control unit 365 stores the set batch quantity N in, for example, the RAM of the memory 320. In the operation example in FIG. 8, the batch quantity N is set to the same value regardless of the denomination.

At step S1005, the counting control unit 365 sets the remaining number of sheets Z until the counted banknotes reach the batch quantity N. At step S1005, since counting of banknotes has not been started yet, the counting control unit 365 sets an initial value of the remaining number of sheets Z to N. Thereafter, the process in FIG. 8 ends.

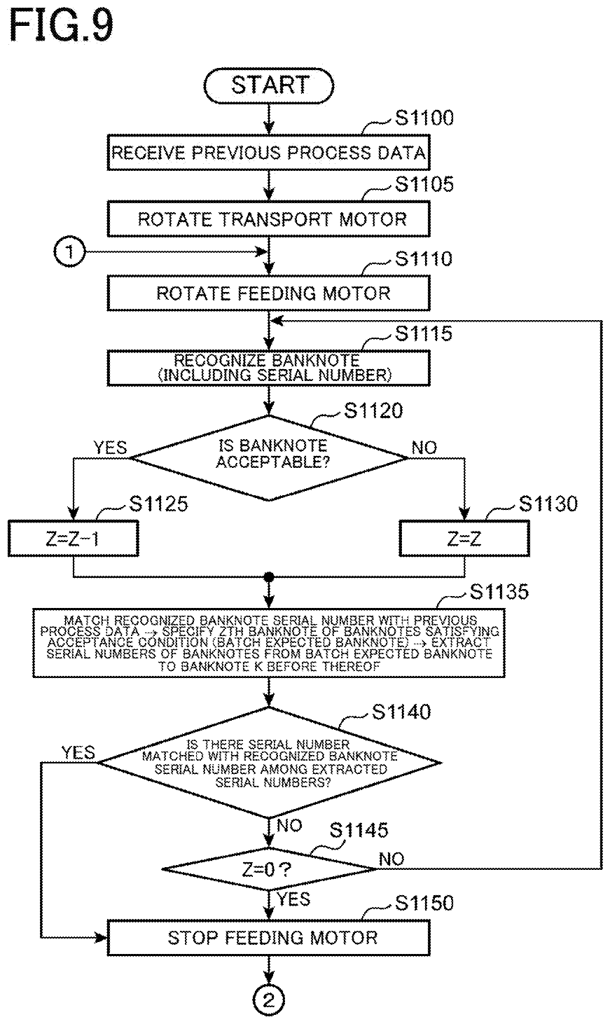

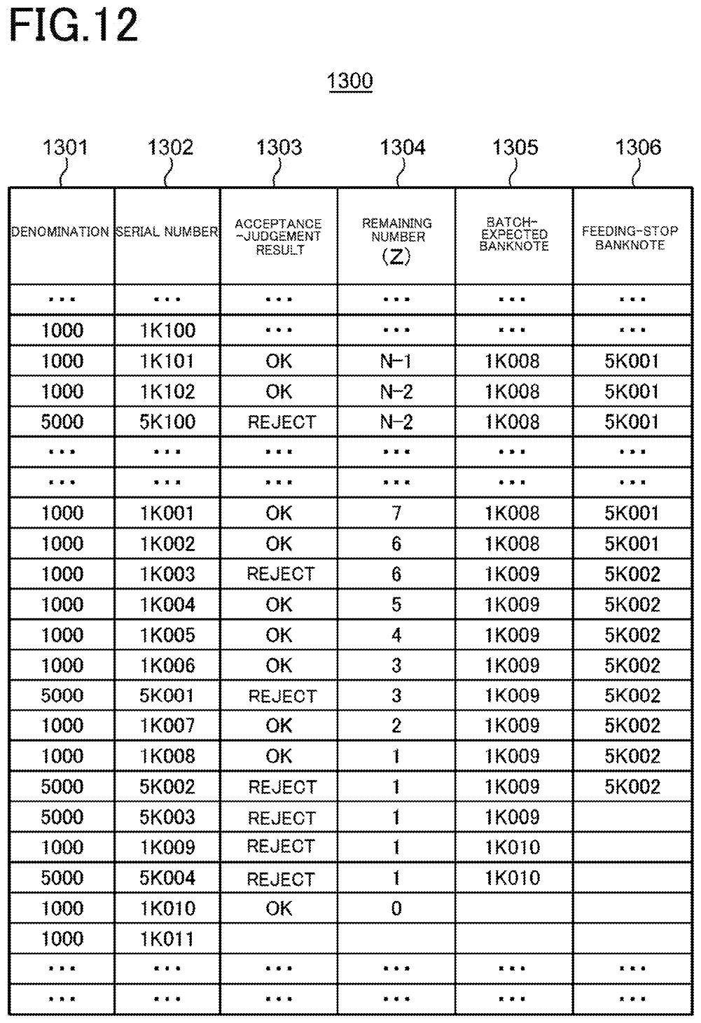

FIG. 9 to FIG. 11 are flowcharts schematically illustrating an example of a banknote counting operation of the counting machine 300. FIG. 12 is a diagram schematically illustrating counting information 1300 for specifically explaining the process of the banknote counting operation in FIG. 9 to FIG. 11.

For example, operations in FIG. 9 to FIG. 11 are started automatically when a bundle of banknotes 190 is newly set in the slot 330a of the counting machine 300 or upon operation of a start switch provided in the counting machine 300. In the present embodiment, the banknotes 190 stored in the storage cassette 140 in the deposit machine 100 are set in the slot 330a of the counting machine 300 in the original order. In the operation examples in FIG. 9 to FIG. 11, the acceptance judgment unit 362 judges not to accept a denomination other than the denomination of “1000 yen”, regardless of an authenticity identification result or the like. That is, in the operation examples in FIG. 9 to FIG. 11, the banknotes 190 with the denomination of “1000 yen” are stored in the storage unit 340a up to the batch quantity N.

As illustrated in FIG. 12, the counting information 1300 includes a denomination column 1301, a serial number column 1302, an acceptance-judgment result column 1303, a remaining number column 1304, a batch-expected banknote column 1305, and a feeding-stop banknote column 1306. The denomination column 1301 and the serial number column 1302 are respectively the same as the denomination column 501 and the serial number column 502 in the previous process data 500 (FIG. 3). The acceptance-judgment result column 1303 represents an acceptance judgment result by the acceptance judgment unit 362. The remaining number column 1304 represents the remaining number of sheets Z until reaching the batch quantity N. The batch-expected banknote column 1305 represents a serial number of a banknote that reaches the batch quantity N specified by the counting control unit 365. The feeding-stop banknote column 1306 represents a serial number of a banknote to be read immediately before the timing to stop feeding of banknotes. That is, when the serial number of a banknote represented in the feeding-stop banknote column 1306 is read, the transport control unit 363 stops the feeding motor 331. The counting information 1300 is simply for specifically explaining the process of the banknote counting operation in FIG. 9 to FIG. 11, and it does not mean that data of the counting information 1300 is generated.

At step S1100 in FIG. 9, the communication IF circuit 350 receives a communication signal including the previous process data 500 (FIG. 3) transmitted from the server device 200. The communication control unit 364 stores the previous process data 500 received by the communication IF circuit 350 in, for example, the RAM of the memory 320. The transport control unit 363 rotates the transport motor 332 at step S1105, and rotates the feeding motor 331 at step S1110.

At step S1115, the acceptance judgment unit 362 recognizes a banknote and the read control unit 361 reads the serial number of the banknote. At step S1120, the acceptance judgment unit 362 judges whether to accept the banknote. When it is judged to accept the banknote (YES at step S1120), the process proceeds to step S1125. On the other hand, when it is judged not to accept the banknote (NO at step S1120), the process proceeds to step S1130.

At step S1125, the counting control unit 365 decrements the remaining number of sheets Z by 1. At step S1130, the counting control unit 365 maintains the same value without decrementing the remaining number of sheets Z.

At step S1115 in FIG. 9, it is assumed that the serial number of a banknote to be read first is “1K101” illustrated in the serial number column 502 in FIG. 3 (the serial number column 1302 in FIG. 12). In the example in FIG. 12, the banknote with the serial number “1K101” is judged to be acceptable at step S1120. Subsequently, at step S1125, the remaining number of sheets Z is decremented by 1, and the remaining number of sheets Z becomes “N−1” as illustrated in the remaining number column 1304 in FIG. 12.

At step S1135 in FIG. 9, the counting control unit 365 matches the serial number read at step S1115 with the serial numbers in the previous process data 500. Hereinafter, the serial number of the banknote read immediately before is referred to as “recognized banknote serial number”. In the present embodiment, the recognized banknote serial number corresponds to an example of the read specific code.

At step S1135, the counting control unit 365 further specifies the Zth banknote of the banknotes satisfying an acceptance condition as a batch expected banknote. As described above, in the example illustrated in FIG. 9 to FIG. 11, since a banknote with the denomination of “5000 yen” is judged not to be acceptable, the “banknote satisfying the acceptance condition” is a banknote with the denomination of “1000 yen”. Therefore, the Zth (at the current moment, Z=N−1) banknote with the denomination of “1000 yen” is specified as the batch expected banknote. In the example illustrated in FIG. 3 (FIG. 12), it is assumed that a banknote with a serial number “1K008” is specified as the batch expected banknote.

At step S1135, the counting control unit 365 further extracts serial numbers of banknotes from the batch expected banknote to a banknote K before thereof from the previous process data 500 (FIG. 3). In the present embodiment, since K=2, in the example of FIG. 3 (FIG. 12), serial numbers “1K008”, “1K007”, and “5K001” are extracted. As a result, as illustrated in FIG. 12, the batch-expected banknote column 1305 becomes “1K008” and the feeding-stop banknote column 1306 becomes “5K001”.

At step S1140, the counting control unit 365 judges whether there is a serial number matched with the recognized banknote serial number among the extracted serial numbers. If there is no serial number matched with the recognized banknote serial number among the extracted serial numbers (NO at step S1140), the process proceeds to step S1145. On the other hand, if there is a serial number matched with the recognized banknote serial number among the extracted serial numbers (YES at step S1140), the process proceeds to step S1150.

At step S1145, the counting control unit 365 judges whether the remaining number of sheets Z is zero. If the remaining number of sheets Z is not zero (NO at step S1145), the process returns to step S1115. On the other hand, if the remaining number of sheets Z is zero (YES at step S1145), the process proceeds to step S1150.

In the example in FIG. 12, a banknote of the second serial number “1K102” is judged to be acceptable at step S1120. At step S1125, the remaining number of sheets Z is then decremented by 1, and the remaining number of sheets Z becomes “N−2” as illustrated in the remaining number column 1304 corresponding to the serial number “1K102” in FIG. 12. Subsequently, a banknote of the third serial number “5K100” is judged not to be acceptable at step S1120. At step S1130, the remaining number of sheets Z is not decremented and the same value is maintained. Therefore, the remaining number Z remains “N−2” as illustrated in the remaining number column 1304 corresponding to the serial number “5K100” in FIG. 12.

If NO at step S1140 and NO at step S1145, the process returns to step S1115 to repeat the steps described above. Thereafter, in the example in FIG. 12, a banknote with the serial number “1K001” is judged to be acceptable at step S1120. Subsequently, at step S1125, the remaining number of sheets Z is decremented by 1. It is assumed that the remaining number of sheets Z becomes “7” as illustrated in the remaining number column 1304 corresponding to the serial number “1K001” in FIG. 12. Further, the next serial number “1K002” is accepted and the remaining number of sheets Z becomes “6”.

At step S1135, a banknote with a serial number “1K008” being the sixth banknote from the serial number “1K002” with the denomination of “1000 yen” is specified as a batch expected banknote, and banknotes with serial numbers “1K008”, “1K007”, and “5K001” up to K before thereof are extracted.

Subsequently, in the example in FIG. 12, a banknote with a serial number “1K003” is judged not to be acceptable at step S1120. Thus, at step S1130, the remaining number of sheets Z is not decremented and “6” is maintained. Therefore, at step S1135, a banknote with a serial number “1K009” being the sixth banknote from the serial number “1K003” with the denomination of “1000 yen” is specified as a batch expected banknote, and banknotes with serial numbers “1K009”, “5K003”, and “5K002” up to K before thereof are extracted, in the same manner as described above. As a result, as illustrated in FIG. 12, the batch-expected banknote column 1305 corresponding to the serial number “1K003” becomes “1K009” and the feeding-stop banknote column 1306 becomes “5K002”.

Subsequently, in the example in FIG. 12, a banknote with a serial number “1K004” is judged to be acceptable at step S1120. At step S1130, the remaining number of sheets Z is then decremented and becomes “5”. Therefore, at step S1135, a banknote with a serial number “1K009” being the fifth banknote from the serial number “1K004” with the denomination of “1000 yen” is specified as a batch expected banknote, and banknotes with serial numbers “1K009”, “5K003”, and “5K002” up to K before thereof are extracted. Hereinafter, the process proceeds in the same manner until a banknote with a serial number “1K008” is read, and when the banknote with the serial number “1K008” is read, the remaining number of sheets Z becomes “1”.

At step S1150 in FIG. 9, the counting control unit 365 notifies the transport control unit 363 to stop the feeding motor 331. Upon reception of the notification, the transport control unit 363 stops the feeding motor 331.

In the example in FIG. 12, the banknote with the serial number “5K002” next to the serial number “1K0038” is judged not to be acceptable at step S1120. Subsequently, at step S1130, the remaining number of sheets Z is not decremented and remains “1” with the same value being maintained.

In this case, at step S1135, the banknote with the serial number “1K009” being the first banknote from the serial number “1K003” with the denomination of “1000 yen” is specified as a batch expected banknote, and banknotes with serial numbers “1K009”, “5K003”, and “5K002” up to K before thereof are extracted. Therefore, at step S1140, the serial number “5K002” of the serial numbers “1K009”, “5K003”, and “5K002” matches with the recognized banknote serial number (YES at step S1140), and the feeding motor 331 is stopped (step 31150).

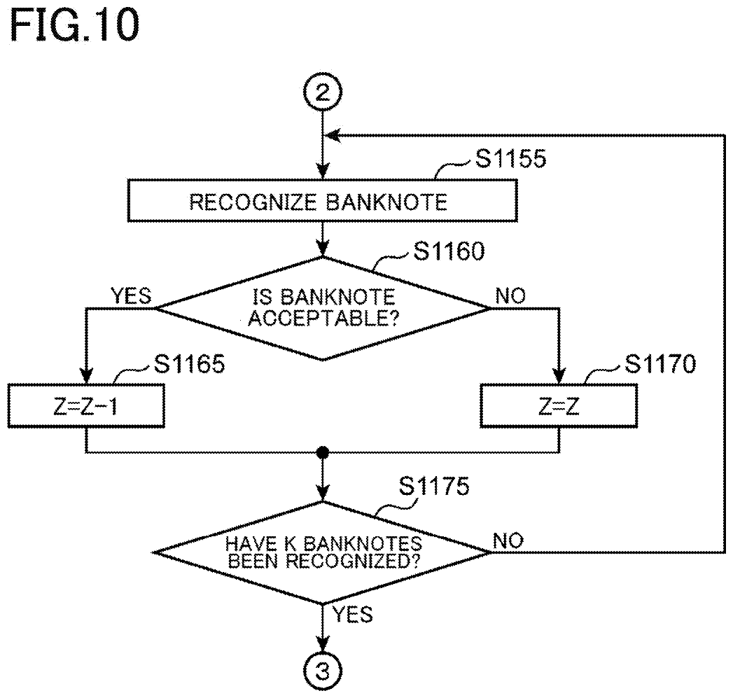

At step S1155 in FIG. 10 following step S1150 (FIG. 9), the acceptance judgment unit 362 recognizes a banknote, and the read control unit 361 reads the serial number of the banknote. At step S1160, the acceptance judgment unit 362 judges whether to accept the banknote. When it is judged to accept the banknote (YES at step S1160), the process proceeds to step S1165. On the other hand, when it is judged not to accept the banknote (NO at step S1160), the process proceeds to step S1170.

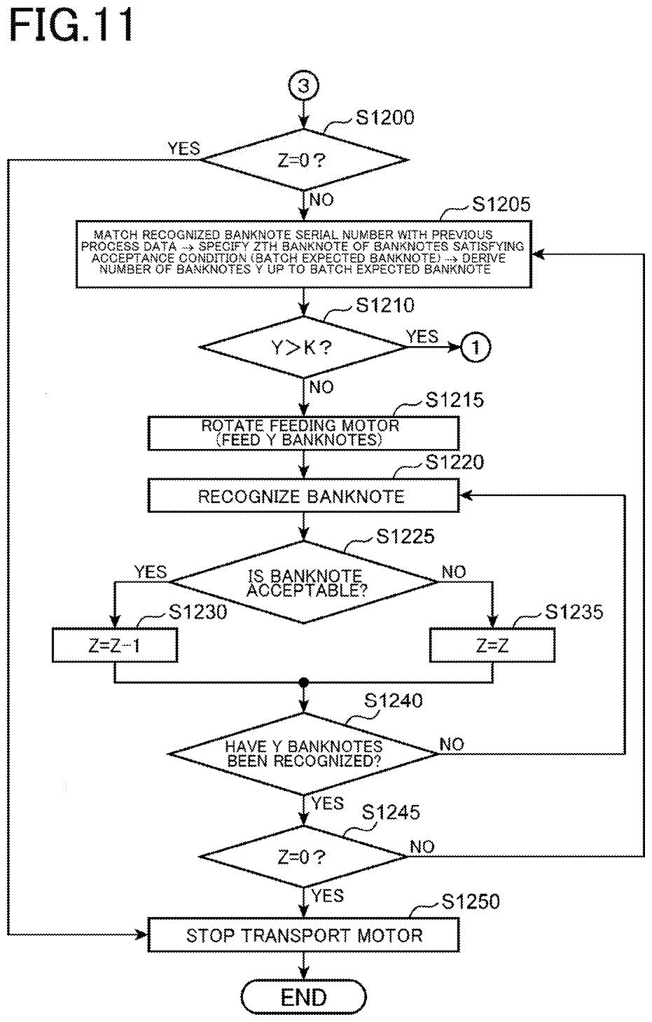

At step S1165, the counting control unit 365 decrements the remaining number of sheets Z by 1. At step S1170, the counting control unit 365 does not decrement the remaining number of sheets Z and maintains the same value. At step S1175, the counting control unit 365 judges whether K banknotes already fed at the time of stopping the feeding motor 331 have been recognized. If K banknotes have not been recognized (NO at step S1175), the process returns to step S1155, to repeat the steps described above. On the other hand, if K banknotes have been recognized (YES at step S1175), the process proceeds to step S1200 (FIG. 11).

At step S1200 in FIG. 11, the counting control unit 365 judges whether the remaining number of sheets Z is zero. If the remaining number of sheets Z is not zero (NO at step S1200), the process proceeds to step S1205. On the other hand, if the remaining number of sheets Z is zero (YES at step S1200), the process proceeds to step S1250.

At step S1205, the counting control unit 365 matches the recognized banknote serial number with the serial numbers in the previous process data 500 (FIG. 3). At step S1205, the counting control unit 365 also specifies the Zth banknote of banknotes satisfying the acceptance condition (that is, banknotes with the denomination of “1000 yen”) as the batch expected banknote. At step S1205, the counting control unit 365 derives the number of banknotes Y up to the batch expected banknote.

At step S1210, the counting control unit 365 judges whether the number of banknotes Y is larger than the feed-out number K. If the number of banknotes Y is larger than the feed-out number K (YES at step S1210), the process returns to step S1110 to repeat the steps described above. On the other hand, if the number of banknotes Y is equal to or smaller than the feed-out number K (NO at step S1210), the process proceeds to step S1215.

At step S1215, the counting control unit 365 notifies the transport control unit 363 to feed Y banknotes by the feeding motor 331. Upon reception of the notification, the transport control unit 363 causes the feeding motor 331 to rotate, thereby feeding Y banknotes.

At step S1220, the acceptance judgment unit 362 recognizes a banknote, and the read control unit 361 reads the serial number of the banknote. At step S1225, the acceptance judgment unit 362 judges whether to accept the banknote. When it is judged to accept the banknote (YES at step S1225), the process proceeds to step 31230. On the other hand, when it is judged not to accept the banknote (NO at step S1225), the process proceeds to step S1235.

At step S1230, the counting control unit 365 decrements the remaining number of sheets Z by 1. At step S1235, the counting control unit 365 does not decrement the remaining number of sheets Z and maintains the same value.

At step S1240, the counting control unit 365 judges whether the acceptance judgment unit 362 has finished recognition of Y banknotes. If recognition of Y banknotes has not finished yet (NO at step 31240), the process returns to step S1220 to repeat the steps described above. On the other hand, if recognition of Y banknotes has finished (YES at step S1240), the process proceeds to step S1245.

At step 31245, the counting control unit 365 judges whether the remaining number of sheets Z is zero. If the remaining number of sheets Z is not zero (NO at step S1245), the process returns to step S1205 to repeat the steps described above. On the other hand, if the remaining number of sheets Z is zero (YES at step S1245), the process proceeds to step S1250.

At step 31250, the counting control unit 365 notifies the transport control unit 363 to stop the transport motor 332. Upon reception of the notification, the transport control unit 363 stops the transport motor 332 after confirming that all the banknotes in the transport path 330b have been stored in the storage unit 340a based on a detection signal from the storage sensor 341a. Thereafter, the process in FIG. 11 ends.

As described above, at step S1140 in FIG. 9, at the point in time when the serial number “5K002” of the serial numbers “1K009”, “5K003”, and “5K002” matches with the recognized banknote serial number (YES at step S1140), and the feeding motor 331 is stopped at step S1150, K banknotes (K=2 in the present embodiment) have been already fed. That is, in the example in FIG. 12, banknotes with the serial numbers “5K003” and “1K009” have been already fed.

In the example in FIG. 12, the banknote with the serial number “5K003” is judged not to be acceptable (NO at step S1160), and the remaining number of sheets Z is maintained as “1” (step S1170). Therefore, the banknote with the serial number “1K009” is maintained as the batch expected banknote. Since the feeding motor 331 has been already stopped, the feeding-stop banknote column 1306 corresponding to the serial number “5K003” is blank. At this point in time, since recognition of K banknotes already fed has not finished (NO at step S1175), a banknote with the next serial number “1K009” is recognized (step S1155).

In the example in FIG. 12, the banknote with the next serial number “1K009” is judged not to be acceptable (NO at step S1160), and thus the remaining number of sheets Z is maintained as “1” (step S1170). At this point in time, recognition of the K banknotes already fed has finished (YES at step S1175), and the remaining number of sheets Z is maintained as “1” (NO at step S1200).

Therefore, at step 31205, a banknote with a serial number “1K010” being the first banknote from the serial number “1K009” with the denomination of “1000 yen” is specified as the Zth batch expected banknote of the banknotes satisfying the acceptance condition. Further, since the number of banknotes Y up to the specified batch expected banknote are two with serial numbers “5K004” and “1K010”, Y=2 is derived.

Therefore, since Y=K=2, at step S1210, Y≤K (NO at step S1210). Thus, at step S1215, two banknotes are fed by the feeding motor 331. “1” is maintained as the remaining number of sheets Z.

When a banknote with the serial number “5K004” is recognized (step S1220), the banknote is judged not to be acceptable (NO at step S1225), and “1” is maintained as the remaining number of sheets Z (step S1235). Since Y (=2) banknotes have not been recognized yet (NO at step S1240), the process returns to step S1220, and the banknote with the serial number “1K010” is recognized.

When the banknote with the serial number “1K010” is recognized (step S1220), in the example in FIG. 12, the banknote is judged to be acceptable (YES at step S1225), and the remaining number of sheets Z is decremented to zero (step S1230). Since Y(=2) banknotes have been recognized (YES at step S1240) and the remaining number of sheets Z is zero (YES at step S1245), the feeding motor 332 is stopped after the banknote with the serial number “1K010” is stored in the storage unit 340a (step S1250).

As described above, the banknotes with the denomination of “1000 yen” are stored in the storage unit 340a up to the batch quantity N, without uselessly rejecting the banknote already fed at the time of stopping the feeding motor 331.

(Effect)

As described above, according to the present embodiment, it is judged whether to accept a banknote 190 fed by the feeding motor 331 of the counting machine 300. When it is judged to accept the banknote 190, the remaining number of sheets Z up to the batch quantity N is decremented by 1. When it is judged not to accept the banknote 190, the remaining number of sheets Z is maintained as it is. The read serial number is matched with the previous process data 500, and the Zth banknote of banknotes satisfying an acceptance condition is specified as a batch expected banknote. Serial numbers of banknotes from the batch expected banknote to K before thereof are extracted from the previous process data 500. If there is a serial number matched with the read serial number among the extracted serial numbers, the feeding motor 331 is stopped. Therefore, when the feeding motor 331 is stopped at the point in time when the serial numbers of banknotes from the batch expected banknote to K before thereof are read, the banknotes up to the batch quantity N have been fed from the slot 330a. Therefore, according to the present embodiment, it can be prevented that the banknotes 190 exceeding the batch quantity N are fed from the slot. As a result, there is such an advantage that even if counting of the banknotes 190 is accelerated, the subsequent banknote 190 already fed is not rejected uselessly.

### (Modified Embodiment

(1) In the above embodiment, the counting machine 300 acquires the previous process data 500 generated by the deposit machine 100 via the network 20 and the server device 200. However, the procedure is not limited thereto. The counting machine 300 can acquire the previous process data 500 not via the network 20 and the server device 200. For example, the counting machine 300 can acquire the previous process data 500 generated by the deposit machine 100 via a portable memory.

The communication IF circuit 150 of the deposit machine 100 can transmit the previous process data 500 by wired communication to a portable memory attached to the deposit machine 100, under control of the communication control unit 164. Alternatively, the communication IF circuit 150 of the deposit machine 100 can transmit the previous process data 500 by near-field wireless communication to a portable memory arranged close to the deposit machine 100, under control of the communication control unit 164. The communication IF circuit 150 and the communication control unit 164 correspond to an example of the first communication unit.

The communication IF circuit 350 of the counting machine 300 can receive the previous process data 500 by wired communication from a portable memory attached to the counting machine 300, under control of the communication control unit 364. Alternatively, the communication IF circuit 350 of the counting machine 300 can receive the previous process data 500 by near-field wireless communication from a portable memory arranged close to the counting machine 300, under control of the communication control unit 364. The communication IF circuit 350 and the communication control unit 364 correspond to an example of the acquisition unit.

According to the modified embodiment, it is permissible that the banknote handling system 10 does not include the network 20 and the server device 200. The portable memory includes, for example, a universal serial bus (USB) memory, a card-type memory such as an SD card memory, an IC tag, and a notebook personal computer (PC).

(2) In the above embodiment, the feed-out number K of the banknotes 190 is set to K=2. However, the number K to be fed is not limited thereto. The feed-out number K of the banknotes 190 is a value decided according to a distance from the slot 330a to the detection unit 310 of the counting machine 300 and the feed rate of the banknotes 190 by the feeding motor 331, and only needs to be an integer equal to or larger than 1.

(3) In the above embodiment, the banknote handling system 10 handles two types of banknotes of 1000 yen and 5000 yen. However, the types of banknotes are not limited thereto. The banknote handling system 10 according to the above embodiment can handle two or more types of banknotes. For example, the banknote handling system 10 according to the above embodiment may handle banknotes of 10000 yen and 2000 yen in addition to the banknotes of 1000 yen and 5000 yen.

(4) In the above embodiment, the banknote handling system 10 handles banknotes issued in Japan. However, the banknote is not limited thereto. For example, the banknote handling system 10 can handle banknotes with a plurality of denominations issued overseas, and banknotes issued overseas and in Japan can be mixed together. In this case, it suffices that pieces of identification data for identifying the authenticity of banknotes such as the width and length of banknotes, the size and position of a watermark region, the position of a serial number, and the like are memorized on a country-by-country basis.

(5) In the above embodiment, the banknote handling system 10 handles banknotes, but the paper sheet to be handled is not limited to banknotes. For example, the banknote handling system 10 can handle paper sheets such as marketable securities having a watermark region.

### REFERENCE SIGNS LIST

10 banknote handling system
100 deposit machine
111, 311 ultraviolet (UV) sensor
112, 312 magnetic sensor
113, 313 camera
114, 314 visible light sensor
135, 335 feeding unit
140 storage cassette
150, 350 communication interface (IF) circuit
161, 361 read control unit
162 authenticity recognition unit
164, 364 communication control unit
190 banknote
200 server device
210, 220 communication IF circuit
241 communication control unit
230 memory
300 counting machine
330 transport unit
331 feeding motor
340a, 340b storage unit
362 acceptance judgment unit
363 transport control unit
365 counting control unit

1. A paper sheet handling system comprising a paper sheet identification device that identifies paper sheets and a paper sheet counting device that counts the paper sheets identified by the paper sheet identification device, wherein
the paper sheet identification device includes
a first feeding unit that feeds one by one a plurality of the paper sheets stacked in a slot,
a first read unit that reads a specific code described on a surface of the paper sheet fed by the first feeding unit to uniquely specify the paper sheet,
a first storage unit that stacks and stores the paper sheets of which the specific codes have been read by the first read unit, and
a data generation unit that generates previous process data including the specific codes read by the first read unit in order of the paper sheets fed by the first feeding unit,
the paper sheet counting device includes
a second feeding unit that feeds one by one the paper sheets taken out from the first storage unit and stacked and arranged in a slot,
a second read unit that reads the specific code described on a surface of the paper sheet fed by the second feeding unit,
an acceptance judgment unit that judges whether to accept the paper sheet fed by the second feeding unit,
a second storage unit that can store therein the paper sheet up to a set batch quantity N,
a transport unit that transports the paper sheet judged to be acceptable by the acceptance judgment unit to the second storage unit,
an acquisition unit that acquires the previous process data,
a transport control unit that controls operations of the second feeding unit and the transport unit,
a memory that memorizes therein a feed-out number K of paper sheets (K is a positive integer), which have been already fed to between the second feeding unit and the second read unit, at a point in time when the specific code of one of the paper sheets is read by the second read unit, and
a counting control unit that counts number of paper sheets to be stored in the second storage unit, based on the previous process data and the specific code read by the second read unit,
the batch quantity N is an integer larger than the feed-out number K,
the counting control unit
subtracts a remaining number of sheets Z by one up to the batch quantity N, every time it is judged to accept the paper sheet after an operation of the second feeding unit has been started,
maintains the remaining number of sheets Z without performing subtraction, when it is judged not to accept the paper sheet,
matches the read specific code that is the specific code read by the second read unit with the previous process data to specify a Zth paper sheet from the paper sheet with the matched specific code as a batch expected paper sheet, every time the specific code is read by the second read unit,
extracts the specific codes from the batch expected paper sheet to a paper sheet K before thereof from the previous process data, and
judges whether any of the specific codes from the batch expected paper sheet to the paper sheet K before thereof matches with the read specific code, and
the transport control unit stops the operation of the second feeding unit, when the counting control unit judges that any of the specific codes from the batch expected paper sheet to the paper sheet K before thereof matches with the read specific code.

2. The paper sheet handling system according to claim 1, wherein
the counting control unit calculates number of paper sheets Y up to the batch expected paper sheet, which is a Zth paper sheet, after the operation of the second feeding unit is stopped and the acceptance judgment unit judges whether to accepts K paper sheets, and
the transport control unit restarts the operation of the second feeding unit to feed the paper sheets by the number of paper sheets Y.

3. The paper sheet handling system according to claim 2, wherein
the counting control unit
subtracts the remaining number of sheets Z by one, every time it is judged to accept the paper sheet after the operation of the second feeding unit is restarted,
maintains the remaining number of sheets Z without performing subtraction, when it is judged not to accept the paper sheet, and
judges whether the remaining number of sheets Z becomes zero, and
the transport control unit
stops an operation of the transport unit, when the counting control unit judges that the remaining number of sheets Z becomes zero.

4. The paper sheet handling system according to claim 1, wherein the paper sheet includes paper sheets issued in a plurality of different countries.

5. The paper sheet handling system according to claim 1, further comprising a management device configured to be able to communicate with the paper sheet identification device and the paper sheet counting device respectively, wherein
the paper sheet identification device further includes a first communication unit that transmits the previous process data to the management device,
the management device includes
a management communication unit that receives the previous process data transmitted from the first communication unit of the paper sheet identification device,
a management memory that memorizes therein the previous process data received by the management communication unit,
the management communication unit transmits the previous process data memorized in the management memory to the paper sheet counting device, and
the acquisition unit receives the previous process data transmitted from the management communication unit.

6. The paper sheet handling system according to claim 1, wherein
the paper sheet identification device further includes a first communication unit that stores the previous process data in a portable memory configured communicably, and
the acquisition unit acquires the previous process data from the portable memory in which the previous process data is stored.

7. A paper sheet handling device comprising:
a memory that memorizes therein a specific code of a paper sheet beforehand;
a feeding unit that feeds the paper sheet;
a read unit that reads the specific code of the paper sheet fed by the feeding unit;
a judgment unit that judges whether the specific code read by the read unit matches with the specific code memorized in the memory; and
a stop unit that stops an operation of the feeding unit when the judgment unit judges that the specific codes match with each other.

8. The paper sheet handling device according to claim 7, comprising a storage unit that can store therein the paper sheets of which the specific codes have been read by the read unit, wherein
the subsequent K paper sheets (K is a positive integer) have been already fed to between the feeding unit and the read unit at a point in time when the specific code of the paper sheet is read by the read unit, and
when a remaining number of the paper sheets to be stored in the storage unit is Z (Z is a positive integer), the memory memorizes therein the specific code of a Z-Kth paper sheet.

9. A paper sheet handling device comprising:
a feeding unit that feeds the paper sheet;
a read unit that reads a specific code of the paper sheet fed by the feeding unit;
a storage unit that stores therein the paper sheets of which the specific codes have been read by the read unit; and
a data generation unit that generates previous process data including the specific codes read by the read unit in order of the paper sheets fed by the feeding unit.
